(19) United States
(12) Patent Application Publication
(10) Pub. No.: US 2008/0303904 A1
(43) Pub. Date: Dec. 11, 2008

(54) RECEIVING ASSEMBLY WITH FUNCTION OF DISPLAYING IMAGES ABOUT OBJECTS THEREIN

(76) Inventor: Chih-Ching Hsieh, Taichung City (TW)

Correspondence Address: Chih-Ching Hsieh, 235 Chung-Ho, Box 8-24, Taipei, TW

(21) Appl. No.: 11/760,799

(22) Filed: Jun. 11, 2007

(51) Int. Cl. H04N 7/18

(52) U.S. Cl. 348/159; 348/E07.086

(57) ABSTRACT

A receiving assembly with a function of displaying images about objects therein, comprises a container having at least one receiving unit; at least one camera unit being installed in the receiving unit for sensing image about objects in the receiving unit and transferring the data; a display unit for receiving image data from the at least one camera unit and displaying the image on a screen of the display unit; the display unit being installed at an exterior of the container; and an operating unit for adjusting display ways of the display unit. By the display unit to display data from the camera unit, the object in the receiving unit can be known. The operating unit serves to divide the screen of the display unit into one frame or a plurality of sub-frames.

### FIELD OF THE INVENTION

The present invention relates to toolboxes, and particularly to a receiving assembly with a function of displaying images about objects therein so that the user can know the image about the objects in the toolbox without needing to open the toolbox.

### BACKGROUND OF THE INVENTION

Currently more and more tools are used in working or daily life. Thus tool boxes are developed for locating the tools. However because there are many tools being used and thus they are located in the box. As too many different kinds of tools are placed in the tool box, they are often not classified or identified. Furthermore, the tools are not located with an order known by the users or according to the indications on the box. As a result, the user can not know the objects in the toolbox, or can not know what tools are placed in the toolbox, even can not know that a tool is placed in which drawer for searching. There are some developments related to toolboxes being disclosed. However all these developments are aimed at the improvement of the mechanical structure of the toolbox, for example installing sliding tracks and elastic units to guide the drawers so that the user can open or close the drawers easily and conveniently, but these improved structures can not resolve above problems about the searching of a tool.

Thus there is an eager demand for a novel design which can improve the prior art defects.

### SUMMARY OF THE INVENTION

Accordingly, the primary object of the present invention is to provide a receiving assembly with a function of displaying images about objects therein so that the user can know the image about the objects in the toolbox without needing to open the toolbox.

To achieve above objects, the present invention provides a receiving assembly with a function of displaying images about objects therein, comprising a container having at least one receiving unit; at least one camera unit being installed in the receiving unit for sensing image about objects in the receiving unit and transferring the data; a display unit for receiving image data from the at least one camera unit and display the image on a screen of the display unit; the display unit being installed at an exterior of the container; and an operating unit for adjusting display ways of the display unit. By the display unit to display data from the camera unit, the object in the receiving unit can be known. The operating unit serves to divide the screen of the display unit into one frame or a plurality of sub-frames.

The various objects and advantages of the present invention will be more readily understood from the following detailed description when read in conjunction with the appended drawing.

### BRIEF DESCRIPTION OF THE DRAWINGS

FIG. 1 is a perspective view showing the structure of the present invention.

FIG. 2 is a schematic perspective view about the first embodiment of the present invention.

FIG. 3 is a schematic perspective view about the second embodiment of the present invention.

FIG. 4 is a schematic perspective view about the third embodiment of the present invention.

FIG. 5 is a schematic perspective view about the fourth embodiment of the present invention.

FIGS. 6 and 7 show the function of the operating unit according to the present invention.

FIG. 8 shows the schematic perspective view about the fifth embodiment of the present invention.

FIG. 9 shows the schematic perspective view about the sixth embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

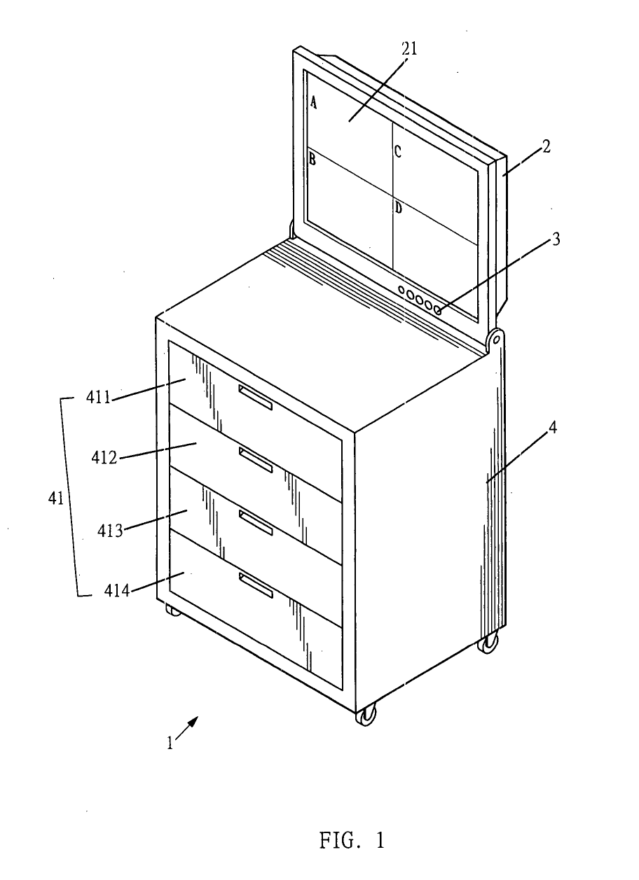

Referring to FIG. 1, the receiving assembly 1 with a function of displaying images therein according to the present invention is illustrated. The present invention has the following elements.

A container 4 has a plurality of receiving units 41 for receiving and storage objects. The receiving units 41 can be opened or closed freely. In this embodiment, the receiving units 40 are drawers.

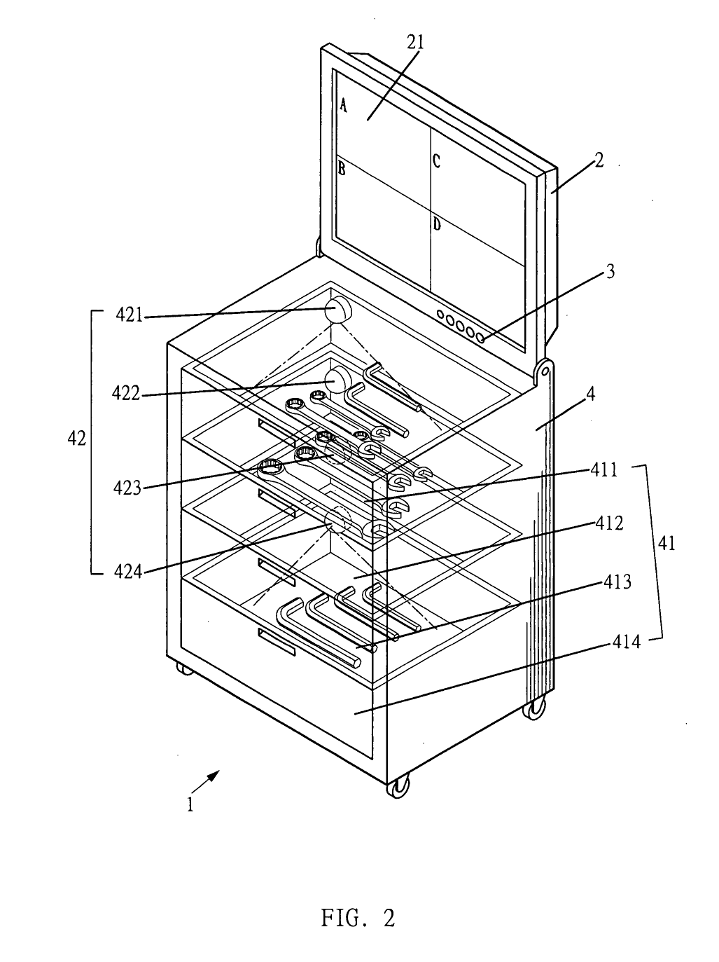

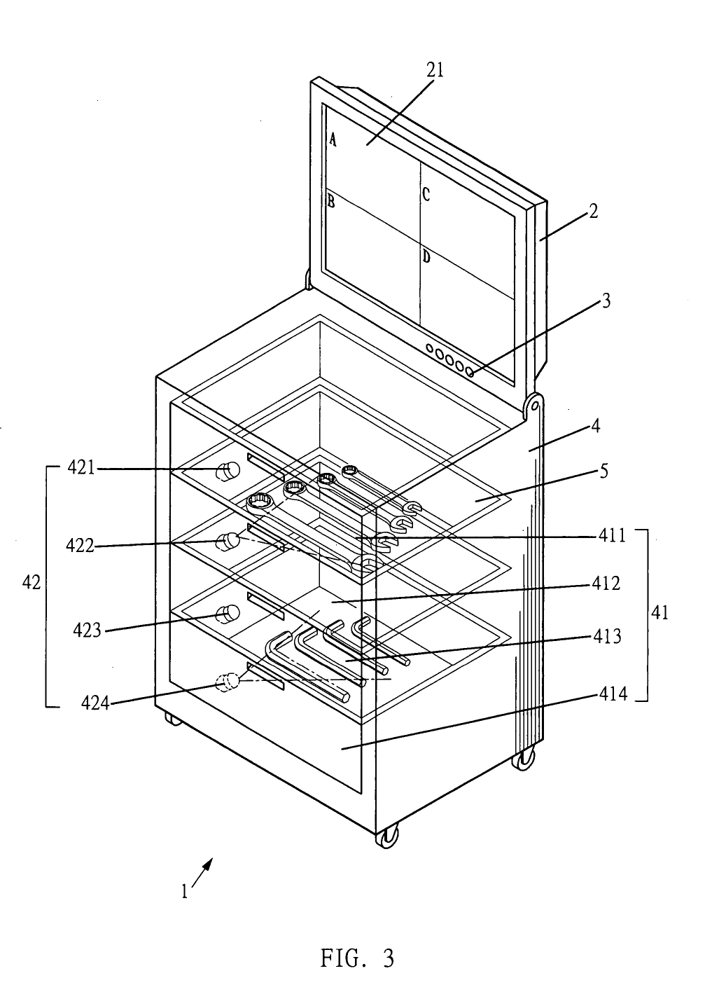

At least one camera unit 42 is included. In this embodiment, each receiving unit 41 has a camera unit 42 (referring to FIGS. 2 and 3) for capturing images of the objects in the receiving unit 41. However in the present invention, maybe some receiving units 41 have no camera unit 42 or one receiving unit 41 has more than one camera unit 42. All these are within the scope of the present invention. The camera unit 42 is installed at different positions of the receiving units 41 for capturing images from different positions. The camera unit 42 captures image data of the object and then transfers the image data.

A display unit 2 is for example a liquid crystal display, an LED display, a cathode ray display, a plasma display, etc. The display unit 2 receives data from the camera unit 42 and then displays the image of the object.

An operating unit 3 is installed near the display unit 2. The operating unit 3 serves to control and adjust the display unit 2. The user changes the displaying way by controlling and adjusting the display unit 2. The frame of the display unit 2 can be divided into a plurality of sub-frames 21 or a single frame 21.

Thus, in use, the receiving assembly 1 of the present invention can display the images about the contents in the container 4. The user can operate the operating unit 3 so as to divide the frame of the display unit 2 into one frame 21 or a plurality of sub-frames 21.

Referring to FIG. 2, in this embodiment, it is illustrated that four camera units are installed, which are a first camera unit 421, a second camera unit 422, a third camera unit 423 and a fourth camera unit 424 which are located in the receiving units 411, 412, 413 and 414, respectively (or receiving units A, B, C, D, respectively.). Each camera unit is installed at a top and near the corner and has a wide range lens. The camera unit faces downwards for capturing images of the receiving unit having the camera unit. The data captured by the camera units 421, 422, 423 and 424 are transferred to the display unit 2 for displaying.

Referring to FIG. 3, a schematic view about the second embodiment of the present invention is illustrated. In this embodiment, those identical to the above embodiment will not be further described herein. Only those differences from above embodiment are described. In this embodiment, all the camera units 421, 422, 423 and 424 are installed at the inner walls of the receiving units 411, 412, 413, and 414 and are faced upwards. The bottom plates of each of the receiving units 411, 412, 413 and 414 are transparent. Thus each of the camera units can capture images of the object in the receiving unit at an upper side.

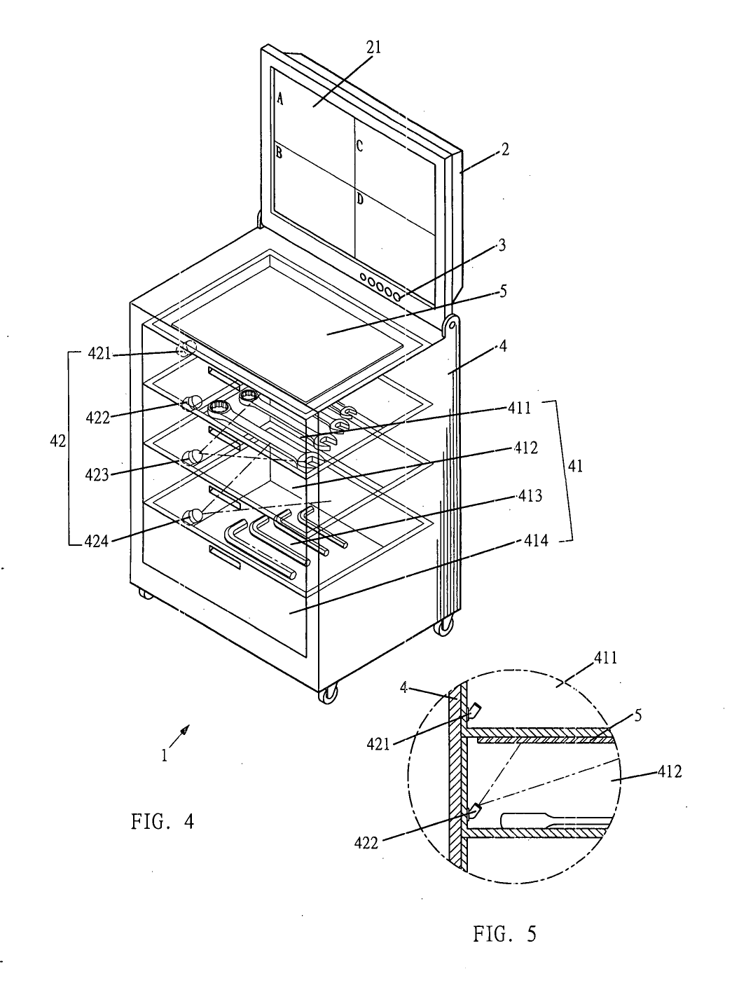

Referring to FIGS. 4 and 5, the third embodiment of the present invention is illustrated. In this embodiment, those identical to the above embodiment will not be further described herein. Only those different from above embodiment are described. In this embodiment, referring to FIG. 5, it is illustrated at an upper side of each receiving unit is installed with a light reflecting plate 5. The images of the objects in one receiving unit will incident into the reflecting plate 5. Then the image upon the plate 5 is captured by a respective one of the camera units and is transferred to the display unit 2.

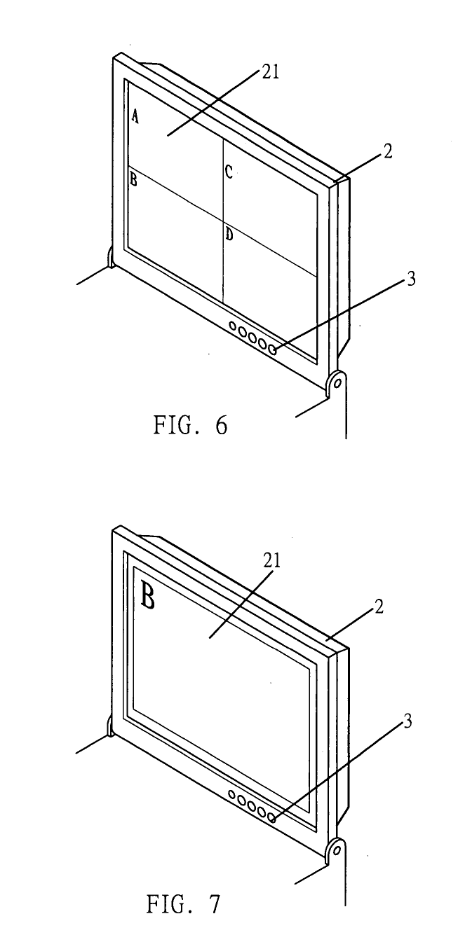

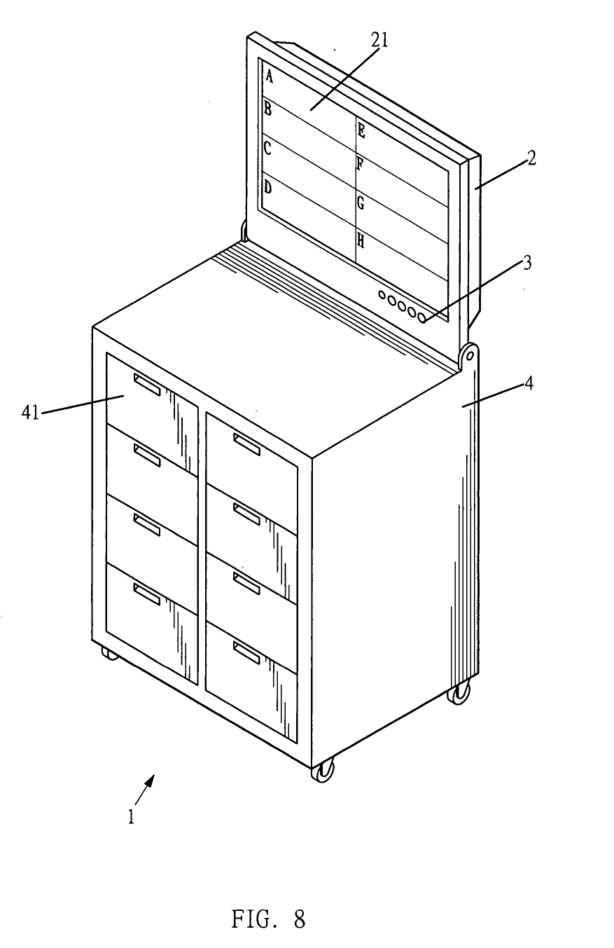

Referring to FIGS. 6 and 7, in FIG. 6, it is illustrated that the frame of the display unit 2 is divided into four sub-frames 21 by adjusting the operating unit 3 or the frame of the spacing 21 has only one frame 21 (see FIG. 7). All these are determined by the requirement of the user.

Referring to FIG. 8, the fourth embodiment of the present invention is illustrated. In this embodiment, those identical to the above embodiment will not be further described herein. Only those different from above embodiment are described. In this embodiment, the container 4 has eight receiving units 41 and the frame of the display unit 2 is divided into eight sub-frames 21.

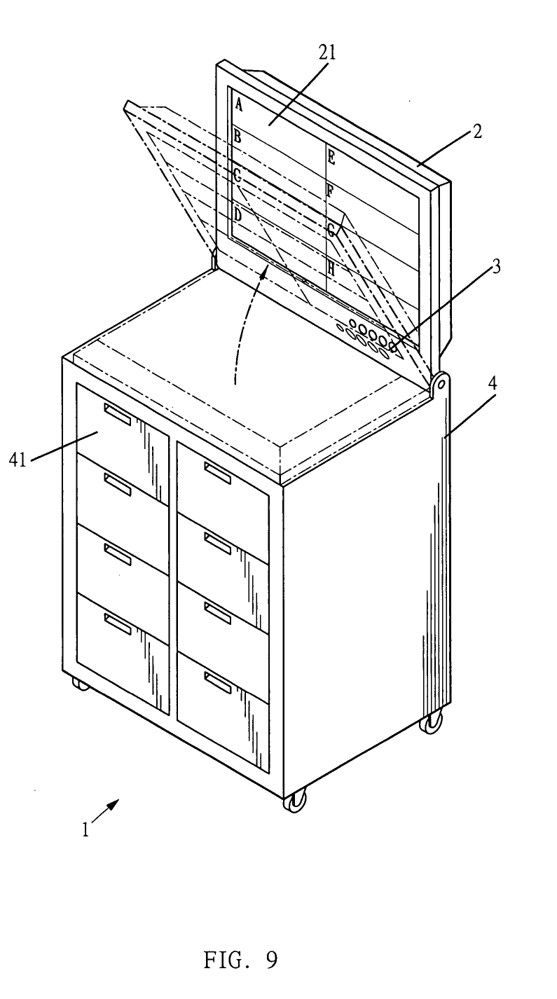

Referring to FIG. 9, the fifth embodiment of embodiment is illustrated. In this embodiment, those identical to the above embodiment will not be further described herein. Only those different from above embodiment are described. It is illustrated in FIG. 9 that the display unit 2 is folded for storage and damage-proof. In FIG. 9, it is illustrated that the display unit 2 is folded to be adhered upon an upper surface of the container 4.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A receiving assembly with a function of displaying images about objects therein, comprising:
a container having at least one receiving unit;
at least one camera unit being installed in the receiving unit for sensing images about objects in the receiving unit and transferring the data;
a display unit for receiving image data from the at least one camera unit and displaying the images on a screen of the display unit; the display unit being installed at an exterior of the container; and
an operating unit for adjusting display ways of the display unit; and
wherein by the display unit to display data from the camera unit, the object in the receiving unit can be known.

2. The receiving assembly with a function of displaying images about objects therein as claimed in claim 1, wherein the operating unit serves to divide the screen of the display unit into one frame or a plurality of sub-frames.

3. The receiving assembly with a function of displaying images about objects therein as claimed in claim 1, wherein each camera unit is installed at a top and near the corner; and the camera unit faces downwards for capturing images of the receiving unit having the camera unit.

4. The receiving assembly with a function of displaying images about objects therein as claimed in claim 1, wherein each camera unit is installed at an inner wall of the respective receiving unit and the camera unit faces upwards for capturing images of the receiving unit at an upper side of the receiving unit having the camera unit.

5. The receiving assembly with a function of displaying images about objects therein as claimed in claim 1, wherein each camera unit is installed at an inner wall of the respective receiving unit and the camera unit faces upwards; and a light reflecting plate is adhered upon an upper surface of a receiving unit; images of the objects in one receiving unit will incident into the reflecting plate.

6. The receiving assembly with a function of displaying images about objects therein as claimed in claim 1, wherein each camera unit has a wide range lens.

7. The receiving assembly with a function of displaying images about objects therein as claimed in claim 1, wherein the display unit is foldable to be placed upon a surface of the container.
